(19) United States
(12) Patent Application Publication
(10) Pub. No.: US 2021/0101111 A1
(43) Pub. Date: Apr. 8, 2021

(54) PROCESS FOR THE REMOVAL OF SULPHUR OXIDES AND NITROGEN OXIDES CONTAINED IN OFF-GAS FROM AN INDUSTRIAL PLANT

(71) Applicant: Haldor Topsøe A/S, Kgs. Lyngby (DK)

(72) Inventors: Joakim Reimer Thøgersen, Virum (DK); Francesco Castellino, Birkerød (DK); Souheil Saadi, Rødovre (DK); Niklas Bengt Jakobsson, Kågeröd (SE)

(73) Assignee: Haldor Topsøe A/S, Kgs. Lyngby (DK)

(21) Appl. No.: 16/479,651

(22) PCT Filed: Feb. 26, 2018
(86) PCT No.: PCT/EP2018/054646

§ 371 Date: Jul. 22, 2019

(30) Foreign Application Priority Data
Mar. 2, 2017 (DK) PA 2017 00147

(51) Int. Cl. B01D 53/60; B01D 46/00; B01D 46/02; B01D 53/50; B01D 53/86

(52) U.S. Cl. CPC B01D 53/60; B01D 2255/50; B01D 46/02; B01D 46/0036; B01D 53/508; B01D 53/8631; B01D 2251/2062; B01D 2253/112; B01D 2239/0478; B01D 2255/1021; B01D 2255/2073; B01D 2255/20738; B01D 2251/304; B01D 2251/606; B01D 2255/1023; B01D 2255/20707; B01D 2255/20723; B01D 2255/20761; B01D 2255/20769; B01D 2255/20776; B01D 46/0027

(57) ABSTRACT

Process for cleaning an off-gas containing sulphur oxides (SOx), nitrogen oxides (NOx) and particulate matter employing SOx adsorption and ammonia-SCR in one filtration unit, in particular a filter bag house with one or more catalysed fabric filter assemblies.

The present invention relates to a process for cleaning an off-gas containing sulphur oxides (SOx), nitrogen oxides (NOx) and particulate matter employing SOx adsorption and ammonia-SCR in one filtration unit, in particular a filter bag house with one or more catalysed fabric filter assemblies.

Selective catalytic reduction (SCR)is primarily a means of converting nitrogen oxides (NOx) into N₂ and H₂O. A reductant, typically anhydrous ammonia or aqueous ammonia, is added to a stream of flue gas or exhaust gas and then adsorbed onto a catalyst.

It is a well-known problem that SCR employing ammonia as reductant flue gases at low temperatures leads to formation of ammonium bisulphate (ABS) resulting in deactivation of the SCR catalyst and sticky layers of ABS on downstream equipment.

SCR catalysts composed of vanadium oxides supported on titania are well known and typically used in stationary applications. Those catalysts are optionally promoted with tungsten and/or molybdenum oxides or various precious metals (such as palladium and platinum). The SCR catalysts are most often employed coated on a monolithic substrate. Other known SCR catalysts include zeolites promoted with copper and/or iron.

The NOx reduction reaction takes place as the gas contacts the SCR catalyst. Ammonia, or a precursor, such as urea is injected and mixed with the gas upstream the SCR catalyst.

The chemical equation for a stoichiometric reaction using either anhydrous or aqueous ammonia for a selective catalytic reduction process is as shown below:

4NO+4NH₃+O₂→4N₂+6H₂O

2NO₂+4NH₃+O₂→3N₂+6H₂O

NO+NO₂+2NH₃→2N₂+3H₂O

Off-gases from certain industrial processes contain beside NOx also SOx.

An example of such processes is coal carbonization to produce coke for the steel industry. Coke oven gas (COG) is a valuable by-product of coal carbonization. COG is a potential feedstock for hydrogen separation, methane enrichment, methanol production and synthesis gas production through partial oxidation of COG. It can also be effectively utilized to produce electricity and liquefied natural gas.

The typical SOx level in COG is 150 mg/Nm³-180 mg/Nm³.

In order to be suitable as a valuable off-gas, COG and other SOx and NOx containing off-gases must be cleaned by removal of these impurities optionally together with dust or particulate matter further contained in the off-gas.

As already mentioned above, a problem in the ammonia-SCR denitrification process of gases with a high content of SOX is formation of ammonium bisulphate. SO₃ reacts with ammonia to produce ammonium sulphate ((NH₄) ₂SO₄) and ABS(NH₄HSO₄) by the following reaction scheme:

2SO₂+O₂→2SO₃

2NH₃+SO₃+H₂O₂O→(NH₄)₂SO₄

NH₃+SO₃+H₂O→NH₄HSO₄

The bulk dew point of ABS at the SCR reactor inlet is typically around 290° C., but the observed dew point is higher due to capillary forces in the micropore structure of the SCR catalyst.

Certain SCR catalysts, such as the vanadium-based catalysts, are particularly sensitive to contamination from ammonium sulphate and especially ammonium bisulphate, which is condensed in the pore structure of the catalyst at lower temperatures, thereby physically blocking the pores and deactivating the catalyst.

One way to avoid the off-gas cleaning below the dew point of ammonium bisulphate is to perform the SCR and SOx adsorption prior to cooling the gas.

On the other hand, operation of the SCR at a low temperature below the dew point of ammonium bisulphate is desirable because of a reduced energy demand and the possibility of separation of valuable organic compounds like benzene, toluene and xylene contained in certain off-gases, when cooling the hot off-gas from production plant prior to the SCR reaction.

Another way to handle this problem is to periodically operating the SCR at a high temperature, where the ammonium bisulphate is released from the catalyst and the catalyst pores are made available for the catalytic reaction. In this way, the catalyst is reactivated.

When employing catalysed fabric bag filters in SCR service and particulate matter filtration, the process must be performed at operation temperatures below the destruction temperature of the bags. Generally, filter bags are only durable up to around 240° C., which makes periodic heat treatment at higher temperatures impossible.

The idea underlying the present invention is to operate a catalysed bag filter in NH3-SCR below the dew point of ammonium bisulphate and simultaneously remove sulphur oxides and the formed ammonium bisulphate by means of a pulverous sulphur adsorbent.

Thus, this invention provides a process for the removal of dust, sulphur oxides, and nitrogen oxides contained in off-gas from an industrial plant comprising the steps of cooling the off-gas to a temperature of between 240 and 160° C.;

passing the cooled off-gas to a filter bag house;

in the filter bag house adding a pulverous sulphur oxide adsorbent and an amount of nitrogen oxide reducing agent in form of ammonia or a precursor thereof to the cooled off-gas and adsorbing on the pulverous sulphur oxide adsorbent the sulphur oxides and ammonium bisulphate formed by reaction with a part of the added amount of ammonia;

passing the thus treated off-gas together with the remaining amount of the ammonia through one or more fabric filter assemblies arranged in the filter bag house and filtering off the dust, the adsorbed sulphur oxides and the adsorbed ammonium bisulphate on dispersion side of the one or more fabric filter bag assemblies; and

reducing or removing content of the nitrogen oxides in the filtered off-gas by selective catalytic reduction with ammonia by contact with an SCR catalyst coated on fabric within permeation side of the one or more filter bag assemblies.

Preferably, the off-gas is cooled by means of indirect heat-exchange in a heat exchanger, which typically is present in most of the existing cleaning systems for the removal of sulphur compounds and ammonium bisulphate. This makes the process according to the invention attractive for retrofit of these cleaning systems.

When operating the process according to the invention, it is preferred to blow a sodium bicarbonate powder comprising adsorbent into the filter bag house together with ammonia as NOx reduction agent. Ammonium bisulphate and sulphur oxides will thereby be adsorbed on the adsorbent powder and are filtered off together with dust and particulate matter on dispersion side of the filter bags assemblies.

Typically, the filter bag house will contain a plurality of fabric filter bags assemblies arranged in usual manner in the house.

The filter bag assemblies may each consist of a single fabric filter bag with an SCR catalyst coated on fabric in the permeation side of the bag.

In another embodiment of the invention, the filter bag assemblies each comprises an outer filter bag and one or more inner filter bags separately and concentrically arranged within the outer tubular filter bag.

The term “outer filter bag” refers to the filter bag through which the process gas passes first, and the term “inner filter bag” refers to the filter bag(s) through which the process gas passes successively after having passed through the outer bag.

The later embodiment has the advantage that either different types and/or amounts of catalysts can be coated on different filter bags in each filter bag assembly.

The SCR catalyst applied on the filter bags comprises vanadium pentoxide and titanium oxide and optionally additionally oxides of tungsten and/or molybdenum.

The catalytically active material can further comprise palladium or platinum in metallic and/or oxidic form.

These catalysts are active both in the removal of VOCs and carbon monoxide and in the removal of nitrogen oxides (NOx) by the SCR reaction with NH₃.

The Pd/V/Ti catalyst is a preferred catalyst because (i) it has a dual functionality (removal of NOx and removal of VOCs), (ii) it is sulphur-tolerant, and (iii) it has a lower SO₂ oxidation activity compared to other catalyst compositions.

In further a preferred embodiment of the invention the SCR catalyst comprises a mixture of oxides of manganese, cerium and iron supported on titania. Such an SCR catalyst has a sufficient catalytic activity at temperatures well below 190° C., e.g. 130° C. Thereby, it is possible to remove or sufficiently reduce ammonia slip from the SCR catalyst at lower temperatures.

Sulphur oxide adsorbent particles present in the process gas will be deposited on the outer surface, i.e. the dispersion side of the fabric filter bag facing the uncleaned off-gas.

Thus, the catalysts loaded onto the outer bag and/or the inner bag(s) are effectively protected against potential catalyst poisons in particular sulphur oxides present contained in the off-gas.

This makes it possible to employ zeolitic material promoted with iron and/or copper as effective SCR catalysts, especially in the low temperature range of the process, including e.g. Cu-SAPO-34 and Cu-SSZ-13.

Further SCR composition useful in the process according to the invention include compositions comprising one or more acidic zeolite or zeotype components selected from the group consisting of BEA, MFI, FAU, FER, CHA, MOR or mixtures thereof physically admixed with one or more redox active metal compounds selected from the group consisting of Cu/AI₂O₃, Mn/Al₂O₃, CeO₂—ZrO₂, Ce—Mn/Al₂O₃ and mixtures thereof, as described in U.S. Pat. No. 9,168,517.

As already mentioned above, the process according to the invention is well suited for the removal of sulphur oxides and ammonium bisulphate in off-gas from coke production and from regenerative oxidation processes with a sulphur containing fuel.

1. Process for the removal of dust, sulphur oxides and nitrogen oxides contained in off-gas from an industrial plant comprising the steps of
cooling the off-gas to a temperature of between 240 and 160° C.;
passing the cooled off-gas to a filter bag house;
in the filter bag house adding a pulverous sulphur oxide adsorbent and an amount of nitrogen oxide reducing agent in form of ammonia to the cooled off-gas and adsorbing on the pulverous sulphur oxide adsorbent the sulphur oxides and ammonium bisulphate formed by reaction with a part of the added amount of ammonia;
passing the thus treated off-gas together with the remaining amount of the ammonia through one or more fabric filter bag assemblies arranged in the filter bag house and filtering off the dust, the adsorbed sulphur oxides and the adsorbed ammonium bisulphate on dispersion side of the one or more fabric filter bag assemblies; and
reducing or removing content of the nitrogen oxides in the filtered off-gas by selective catalytic reduction with ammonia by contact with an SCR catalyst coated on fabric within permeation side of the one or more filter bag assemblies.

2. The process of claim 1, wherein main part of the adsorbed sulphur oxides consists of SO₃.

3. The process of claim 1, wherein the off-gas is cooled by heat exchange.

4. The process of claim 1, wherein the pulverous sulphur oxide adsorbent comprises sodium bicarbonate.

5. The process of claim 1, wherein each of the one or more filter bag assemblies consists of a single fabric filter bag.

6. The process of claim 1, wherein the one or more filter bag assemblies each comprises an outer filter bag and one or more inner filter bags separately and concentrically arranged within the outer filter bag.

7. The process of claims 1, wherein the SCR active catalyst comprises vanadium pentoxide and titanium oxide.

8. The process of claim 7, wherein the SCR active catalyst further comprises oxides of tungsten and/or molybdenum.

9. The process of claim 7, wherein the SCR active catalyst further comprises palladium or platinum in metallic and/or oxidic form.

10. The process of claim 1, wherein the SCR active catalyst comprises a mixture of oxides of manganese, iron and cerium supported on titania.

11. The process of claim 1, wherein the SCR active catalyst comprises zeolitic material promoted with iron and/or copper.

12. The process of claim 1, wherein the SCR active catalyst comprises one or more acidic zeolite or zeotype components selected from the group consisting of BEA, MFI, FAU, FER, CHA, MOR or mixtures thereof physically admixed with one or more redox active metal compounds selected from the group consisting of Cu/AI₂O₃, Mn/Al₂O₃, CeO₂—ZrO₂, Ce—Mn/Al₂O₃ and mixtures thereof.

13. The process of claim 1, wherein the off-gas originates from a regenerative oxidation process with a sulphur containing fuel.

14. The process of claim 1, wherein the off-gas originates from production of coke.
